(19) United States
(12) Patent Application Publication
(10) Pub. No.: US 2015/0097388 A1
(43) Pub. Date: Apr. 9, 2015

(54) INSIDE REARVIEW MIRROR ASSEMBLY

(71) Applicant: GM GLOBAL TECHNOLOGY OPERATIONS LLC, Detroit, MI (US)

(72) Inventor: Anthony A. Bosco, Macomb Township, MI (US)

(73) Assignee: GM GLOBAL TECHNOLOGY OPERATIONS LLC, Detroit, MI (US)

(21) Appl. No.: 14/047,485

(22) Filed: Oct. 7, 2013

(51) Int. Cl. B60R 1/04

(52) U.S. Cl. CPC B60R 1/04
USPC 296/84.1; 359/871

(57) ABSTRACT

An inside rearview mirror assembly can hold a tag, such as a parking tag. The inside rearview mirror assembly includes a mirror and a housing. The housing is coupled to the mirror and includes a housing body and a holder protruding from the housing body in a direction away from the mirror. The holder includes a holder body and defines a groove disposed along the holder body. The groove is configured to receive the tag.

### TECHNICAL FIELD

The present disclosure relates to an inside rearview mirror assembly capable of holding a tag.

### BACKGROUND

Vehicles typically include a rearview mirror assembly. The rearview mirror assembly includes a mirror that allows a vehicle operator to view objects behind the vehicle.

### SUMMARY

The present disclosure relates to an inside rearview mirror assembly capable of holding a tag such as a parking tag. The inside rearview mirror assembly includes a stem connected to another part of the vehicle such as the vehicle body or windshield. As used herein, the term “stem” refers to a coupler, such as a tube or rod, connecting the housing to another part of a vehicle. Some vehicles include an electronic components housing or casing adjacent to the stem. The electronic components casing houses a plurality of electronic components such as sensors. The electronic components casing may limit the space between the inside rearview mirror assembly and the windshield or vehicle body, thereby limiting the space available to hang a tag on the stem of the inside rearview mirror assembly. It is therefore useful to develop an inside rearview mirror assembly capable of holding a tag, such as a parking tag, in a location spaced apart from the stem.

The present disclosure relates to an inside rearview mirror assembly capable of holding a tag such as a parking tag. In an embodiment, the inside rearview mirror assembly includes a mirror and a housing. The housing is coupled to the mirror and includes a housing body and a holder protruding from the housing body in a direction away from the mirror. The holder includes a holder body and defines a groove disposed along the holder body. The groove is configured to receive the tag.

The present disclosure also relates to vehicles such as cars and trucks. In an embodiment, the vehicle includes a vehicle body including a first end portion and a second end portion opposite the first end portion. The vehicle further includes an inside rearview mirror assembly configured to hold a tag. The inside rearview mirror assembly is coupled relative to the vehicle body and includes a mirror including a reflective surface facing the second end portion of the vehicle body. The inside rearview mirror further includes a housing coupled to the mirror. The housing includes a housing body and a holder protruding from the housing body in a direction toward the first end portion of the vehicle body. The holder includes a holder body and defines a groove disposed along the holder body. The groove is configured to receive the tag. The inside rearview mirror further includes a stem coupling the housing relative to the vehicle body. The stem is spaced apart from the holder.

The present disclosure further relates to an inside rearview mirror housing capable of holding a tag. In an embodiment, the inside rearview mirror housing includes a housing body elongated along a first direction and a holder protruding from the housing body. The holder includes a holder body elongated along a second direction. The first direction is perpendicular to the second direction. The holder defines a groove disposed along the holder body. The groove is configured to receive the tag.

The above features and advantages, and other features and advantages, of the present invention are readily apparent from the following detailed description of some of the best modes and other embodiments for carrying out the invention, as defined in the appended claims, when taken in connection with the accompanying drawings.

### BRIEF DESCRIPTION OF THE DRAWINGS

FIG. 1 is a schematic side view of a vehicle including an inside rearview mirror assembly in accordance with an embodiment of the present disclosure;

FIG. 2 is a schematic perspective view of an inner portion of the vehicle shown in FIG. 1, depicting the inside rearview mirror assembly and an electronic components casing;

FIG. 3 is a schematic side view of the inside rearview mirror assembly and the electronic components casing shown in FIG. 2;

FIG. 4 is a schematic perspective view of the inside rearview mirror assembly without a stem;

FIG. 5 is a schematic side view of the inside rearview mirror assembly of FIG. 2;

FIG. 6 is a schematic front view of the inside rearview mirror assembly without the stem;

FIG. 7 is a schematic perspective view of a portion of the inside rearview mirror assembly in accordance with an another embodiment of the present disclosure;

FIG. 8 is a schematic side view of the inside rearview mirror shown in FIG. 7; and

FIG. 9 is a schematic perspective view of a spacer of the inside rearview mirror shown in FIG. 7.

### DETAILED DESCRIPTION

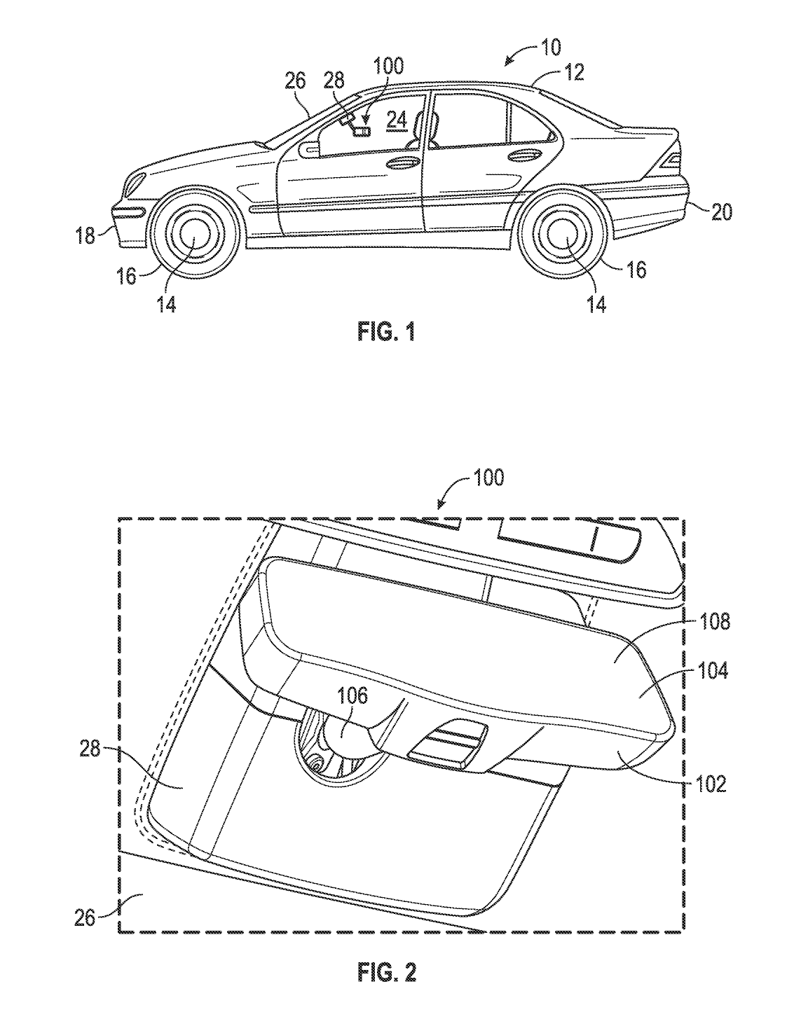

Referring now to the drawings, wherein the like numerals indicate corresponding parts throughout the several views, FIG. 1 schematically illustrates a vehicle 10. The vehicle 10 includes a vehicle body 12, wheels 14 operatively coupled to the vehicle body 12, and tires 16 operatively coupled to the wheels 14. The vehicle body 12 includes a front or first end portion 18 and a rear or second end portion 20 opposite to the first end portion 18. Additionally, the vehicle body 12 defines a passenger compartment 24 for accommodating a vehicle operator and one or more passengers.

The vehicle 10 additionally includes a windshield 26 (e.g., front windshield) operatively coupled to the vehicle body 12 and an electronic components casing 28 operatively coupled to the vehicle body 12 or windshield 26. The electronic components casing 28 may contain sensors and different electronic components. As a non-limiting example, the electronic components casing 28 may contain a photosensor for detecting light in order to automatically active or deactivate the headlamps (not shown) of the vehicle 10 at dusk/dawn. Also, the electronic components casing 28 may include a microphone for detecting vocal inputs from vehicle occupants. Additionally, the electronic components casing 28 may include a rain sensor (not shown) for detecting rain in order to automatically active the wipers (not shown) of the vehicle 10.

The vehicle 10 further includes an inside rearview mirror assembly 100 operatively coupled to the vehicle body 12. For example, the inside rearview mirror assembly 100 may be operatively coupled to the vehicle body 12 through the windshield 26 or the electronic components casing 28. In other words, the inside rearview mirror assembly 100 is coupled or fixed relative to the vehicle body 12.

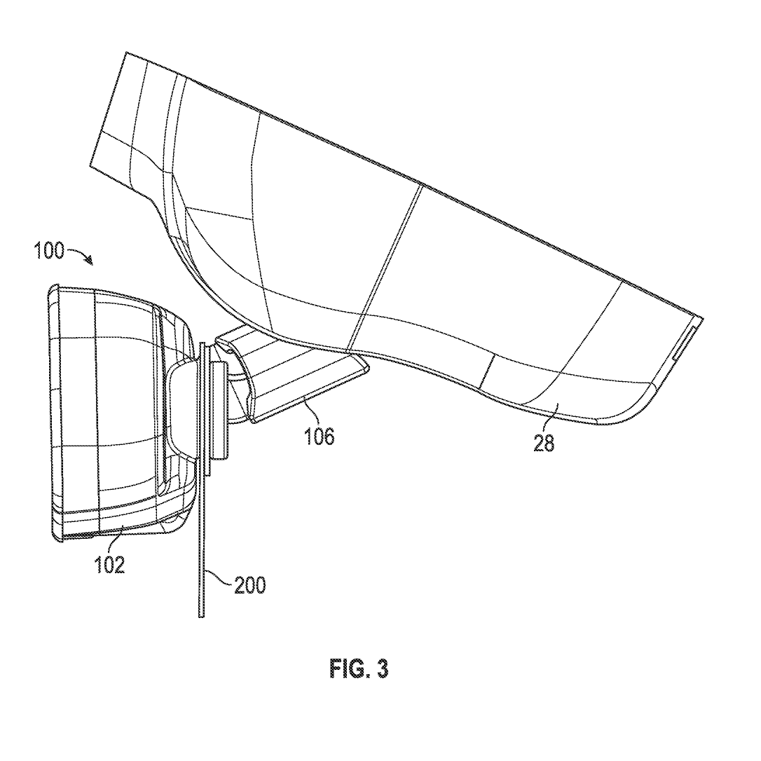

With reference to FIGS. 2 and 3, the inside rearview mirror assembly 100 includes a housing 102, a mirror 104 supported by the housing 102, and a stem 106 coupling the housing 102 to the vehicle body 12 via the electronic components casing 28 or the windshield 26 (FIG. 1). The stem 106 therefore couples the housing 102 relative to the vehicle body 12. In the depicted embodiment, the stem 106 is directly coupled to the electronic components casing 28. It is envisioned, however, that the stem 106 may be directly coupled to another part of the vehicle 10, such as the windshield 26 or the vehicle body 12. Regardless, the stem 106 may be fixed relative to the vehicle body 12.

The housing 102 is movably coupled to the stem 106 to allow a vehicle occupant to adjust the position of the housing 102 relative to the vehicle body 12. For example, the housing 102 may be pivotally coupled to the stem 106. As discussed in detail below, the housing 102 can hold a tag 200, such as a parking tag or event tag.

The mirror 104 is coupled to the housing 102 and includes a reflective surface 108. The reflective surface 108 faces the second end portion 20 of the vehicle body 12 and allows a vehicle occupant to view objects behind the vehicle 10.

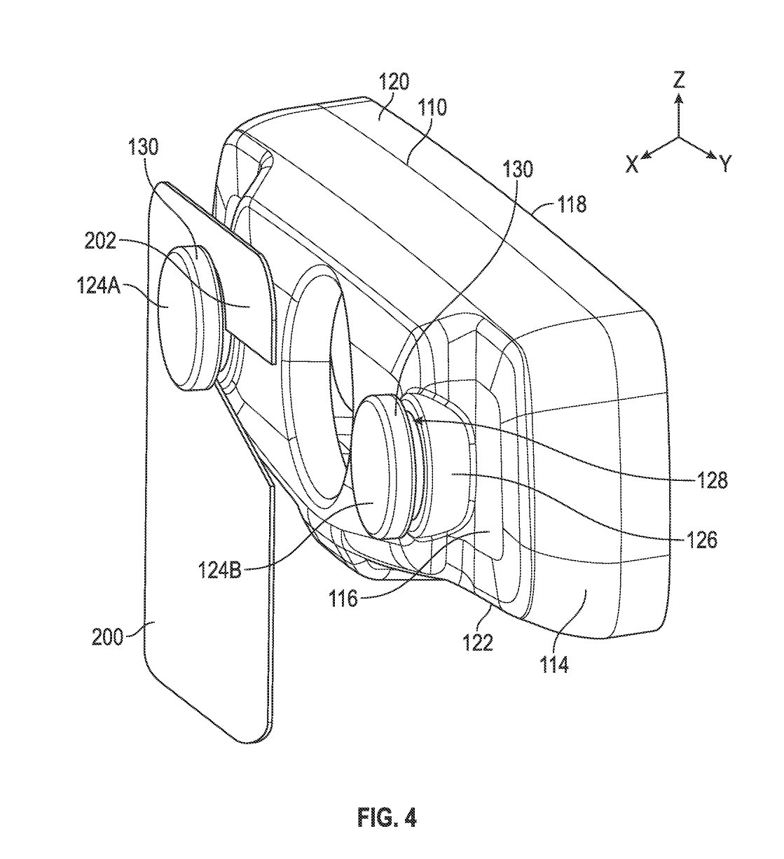

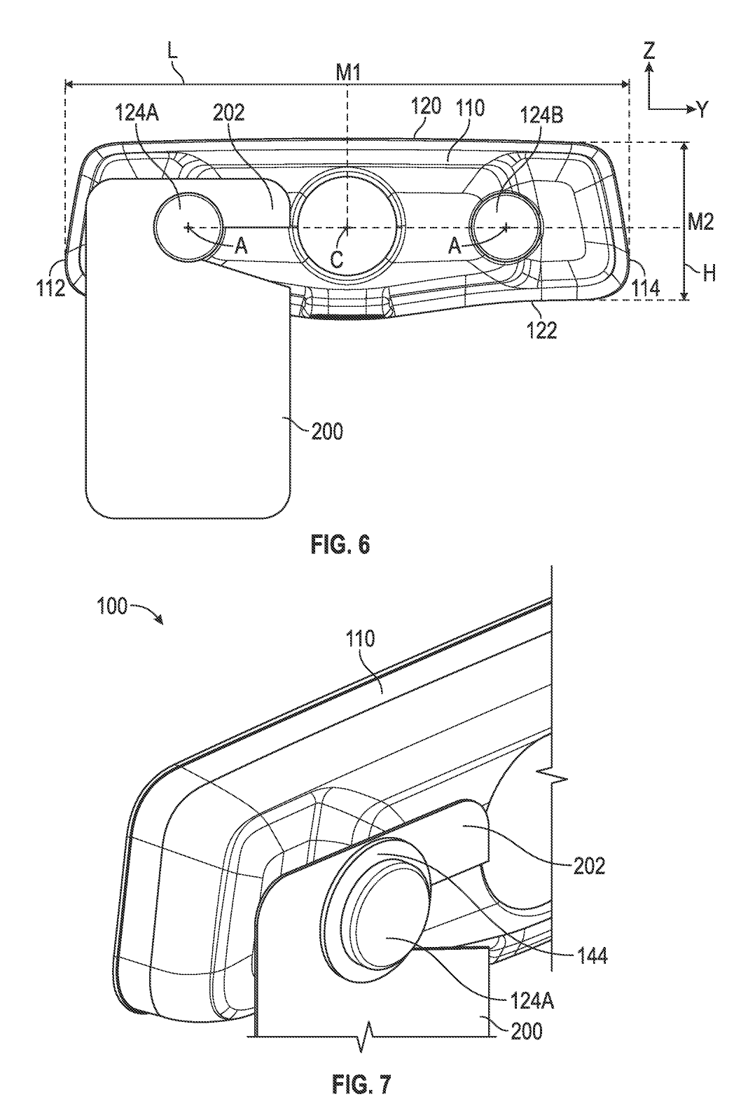

With reference to FIGS. 4-6, the housing 102 includes a housing body 110 configured to be coupled to the stem 106 (FIG. 4). The housing body 110 can support the mirror 104 (FIG. 2) and is elongated along a first direction Y. Specifically, the housing body 110 defines a first edge 112 and a second edge 114 opposite the first edge 112 and may be wholly or partly made of a substantially rigid material such as a rigid polymer or a metal. The housing body 110 defines a housing length L extending from the first edge 112 to the second edge 114 along the first direction Y. The housing body 110 also defines a midpoint M1 at the middle of the housing length L. The midpoint M1 of the housing length L may also be referred to as length midpoint.

The housing body 110 further includes a first or front surface 116 and a second or rear surface 118 opposite the first surface 116. The first surface 116 may be spaced from the second surface 118 along a second direction X. The second direction X is substantially perpendicular to the first direction Y. The mirror 104 (FIG. 2) is attached to the second surface 118 of the housing body 110.

The housing body 110 further includes a top or third surface 120 and a bottom or fourth surface 122 opposite the third surface 120. The third surface 120 is spaced from the fourth surface 122 along a third direction Z. The third direction Z is substantially perpendicular to the first direction Y and second direction X. The housing body 110 defines a housing height H that extends from the fourth surface 122 to the third surface 120 along the third direction Z. Further, the housing body 110 defines a midpoint M2 at the middle of the housing height H. The midpoint M2 of the housing height H may also be referred to as height midpoint. Moreover, the housing body 110 defines a center C substantially aligned with the midpoint M1 of the housing length L and midpoint M2 of the housing height H.

With continued reference to FIGS. 4-6, the housing 102 further includes a first holder 124A and a second holder 124B protruding from the housing body 110 in the second direction X. In other words, the first and second holders 124A, 124B may protrude from the housing body 110 in a direction away from the mirror 104. Accordingly, the second direction X may also be referred to as “a direction away from the mirror 104.” The first and second holders 124A, 124B may protrude in a direction toward the first end portion 18 of the vehicle body 12 or in a direction away from the second end portion 20 of the vehicle body 12. In other words, the first and second holders 124A, 124B may protrude toward the windshield 26. Accordingly, the second direction X may also be referred to as “a direction toward the windshield 26,” “a direction toward the first end portion 18,” or “a direction away from the second end portion 20.” In the depicted embodiment, the first and second holders 124A, 124B protrude from the first surface 116 of the housing body 110 from a location offset from the center C. Specifically, each holder 124A, 124B is offset from the midpoint M1 of the housing length L but substantially aligned with the midpoint of the housing height H. The holders 124A, 124B may be monolithically formed with the housing body 110. For example, the holders 124A, 124B may be molded with the housing body 1110. Alternatively, the holders 124A, 124B may be discrete components attached to the housing body 110. Although the drawings depict the housing 102 with two holders 124A, 124B, it is contemplated that the housing 102 may include more or fewer holders. The first and second holders 124A, 124B may be referred to as first and second pins or first and second bosses.

The first and second holders 124A, 124B may be wholly or partly made of a substantially rigid material, such as a rigid polymer or metal, and may be substantially similar or identical to each other. Each of the first and second holders 124A, 124B is configured to hold the tag 200. For instance, in the depicted embodiment, the first and second holders 124A, 124B are identical. However, the second holder 124A is spaced apart from the first holder 124A along the first direction Y. Each of the first and second holders 124A, 124B defines a holder center A that is substantially aligned with the center C of the housing body 110.

As discussed above, each of the first and second holders 124A, 124B includes a holder body 126. The holder body 126 may have a substantially cylindrical shape and is elongated along the second direction X. Each of the first and second holders 124A, 124B defines a groove 128 disposed along each holder body 126. Each groove 128 extends into the holder body 126 and is configured, sized, and shaped to receive a portion of the tag 200. Each groove 128 may extend along the entire perimeter of the corresponding holder body 126. It is contemplated, however, that the groove 128 may extend only along a portion of the perimeter of the corresponding holder body 126. If the holder body 126 has a substantially cylindrical shape, the groove 128 may extend along the entire circumference of the holder body 126 or only along a portion of the circumference of the holder body 126.

Each holder 124A, 124B further includes a wall 130 disposed adjacent the groove 128. The holder body 126 is spaced from the wall 120 so as to define the groove 128. The wall 130 may be substantially shaped as a disc and can retain the tag 200 in the groove 128.

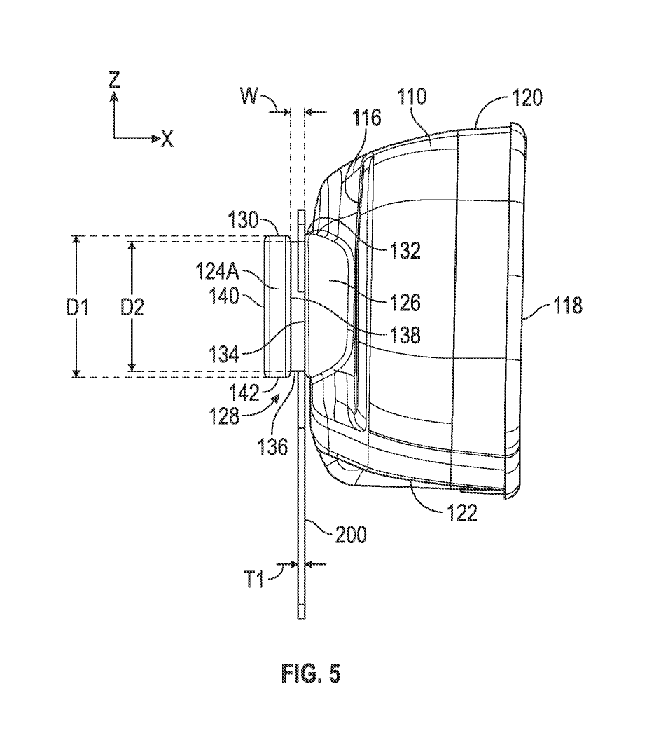

With specific reference to FIG. 5, in the interest of brevity, only the first holder 124A only is described below. However, the second holder 124B may include the same features as the holder 124B. The holder body 126 includes a first body surface 132 defining a first cross-sectional dimension D1. Thus, the holder body 126 has the first cross-sectional dimension D1 defined along the first body surface 132. The first cross-sectional dimension D1 may be a diameter. Accordingly, the first cross-sectional dimension D1 may be referred to as the first diameter. The first body surface 132 may be a circumferential surface and may be directly attached to the housing body 110. The holder body 126 further includes a second body surface 134. The second body surface 134 may be an annular surface and is directly connected to the first body surface 132. The holder body 126 further includes a third body surface 136 directly connected to the second body surface 134. The third body surface 136 may be a circumferential surface and defines a second cross-sectional dimension D2. Thus, the holder body 126 has the second cross-sectional dimension D2 defined along the third body surface 136. The second cross-sectional dimension D2 may be a diameter. Accordingly, the second cross-sectional dimension D2 may be referred to as the second diameter. The second cross-sectional dimension D2 is less than the first cross-sectional dimension D1.

With continued reference to FIG. 5, the wall 130 includes a first wall surface 138, a second wall surface 140 opposite the first wall surface 138, and a third wall surface 142 interconnecting the first and second wall surfaces 138, 140. The first wall surface 138 may be an annular surface and is directly connected to the third body surface 136. The third wall surface 142 may be a circumferential surface and is directly connected to the first wall surface 138 and second wall surface 140. In addition, the wall 130 has a cross-sectional dimension defined along the third wall surface 142, which may be substantially similar or the same as the first cross-sectional dimension D1. The first wall surface 138, second body surface 134, and third body surface 136 jointly define the groove 128.

With continued reference to FIG. 5, the groove 128 has a width W that extends from the first wall surface 138 to the second body surface 134 along the second direction X. The tag 200 may have a thickness T1, which is less than the width W of the groove 128. Accordingly, the groove 128 is sized to receive the tag 200.

With reference again to FIGS. 4-6, the tag 200 may have a substantially planar shape and includes a hook 202 configured, shaped, and sized be received in the groove 128. The hook 202 may have the same thickness T1 as the rest of the tag 200. To hold the tag 200 with the inside rearview mirror assembly 100, the user may hang the hook 202 on one of the holders 124A, 124B. Specifically, the user can place at least a portion of the hook 202 of the tag 200 in the groove 128. When the hook 202 is placed in the groove 128, the hook 202 rests on the third body surface 136 of the holder body 126 and, consequently, the holder 124A or 124B holds the tag 200.

With reference to FIGS. 7-9, the inside rearview mirror assembly 100 may further include at least one spacer 144 configured to secure the tag 200 in the groove 128 (FIG. 5). The spacer 144 may have a substantially annular shape and, as such, may be referred to as a ring.

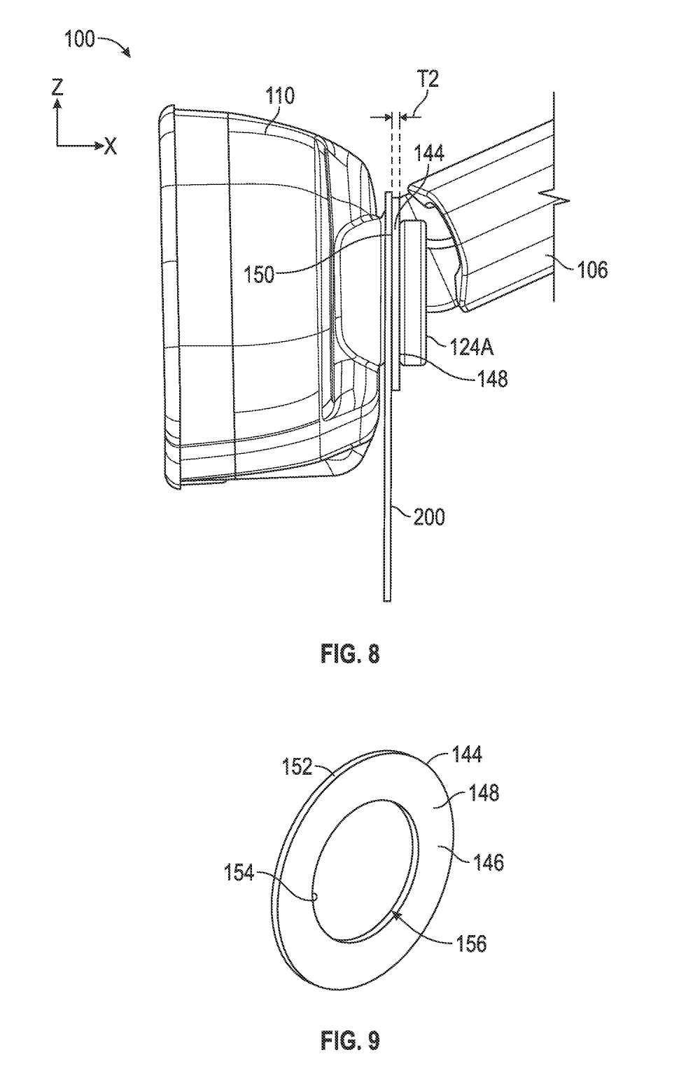

With specific reference to FIG. 9, the spacer 144 includes a substantially annular spacer body 146. The spacer body 144 defines a first or front spacer surface 148, a second or rear spacer surface 150 (FIG. 8) opposite the first spacer surface 148, a third or outer spacer surface 152, and a fourth or inner spacer surface 154. The fourth spacer surface 154 defines a hole 156 that extends through the spacer body 144. The hole 156 is configured, shaped, and sized to receive at least a portion of the holder body 126. The spacer 144 may be wholly or partly made of a substantially elastic material. Accordingly, the spacer 144 may be manually stretched so that it can be placed in the groove 128 (FIG. 5). Alternatively, the spacer 144 may include a slit (not shown) that allows the spacer 144 to be expanded so that it can be placed in the groove 128 (FIG. 5).

With reference again to FIGS. 7-9, the spacer 144 may have a thickness T2 that extends from the first spacer surface 148 to the second spacer surface 150 along the second direction X. The thickness T2 of the spacer 144 is less than the width W of the groove 128 (FIG. 5). The spacer 144 should be sufficiently thick to retain the tag 200 in the groove 128 (FIG. 5) when the hook 202 is disposed in the groove 128. For this reason, the inside rearview mirror assembly 100 may include a plurality of spacers 144 having different thicknesses T2. The width W of the groove 128 (FIG. 5) is substantially similar or greater than the thickness of the spacer T2 and the thickness T1 of the tag 200 combined. Accordingly, when the spacer 144 and the hook 202 are placed in the groove 128 (FIG. 5), the spacer 144 minimizes the movement of the tag 200 relative to the holder 126 and the housing body 110.

The detailed description and the drawings or figures are supportive and descriptive of the invention, but the scope of the invention is defined solely by the claims. While some of the best modes and other embodiments for carrying out the claimed invention have been described in detail, various alternative designs and embodiments exist for practicing the invention defined in the appended claims.

1. An inside rearview mirror assembly capable of holding a tag, the inside rearview mirror assembly comprising:
a mirror;
a housing coupled to the mirror, the housing including a housing body and a holder protruding from the housing body in a direction away from the mirror, the holder including a holder body; and
wherein the holder defines a groove disposed along the holder body, and the groove is configured to receive the tag.

2. The inside rearview mirror assembly of claim 1, wherein the housing body defines a center and the holder is offset from the center of the housing body.

3. The inside rearview mirror assembly of claim 2, further comprising a stem protruding from the center of the housing, the stem being configured to fix the housing relative to a vehicle body.

4. The inside rearview mirror assembly of claim 1, wherein the groove has an annular shape.

5. The inside rearview mirror assembly of claim 1, wherein the groove is disposed along an entire perimeter of the holder.

6. The inside rearview mirror assembly of claim 1, further comprising a spacer disposed in the groove.

7. The inside rearview mirror assembly of claim 6, wherein the spacer is made of an elastic material.

8. The inside rearview mirror assembly of claim 6, wherein the spacer has an annular shape.

9. The inside rearview mirror assembly of claim 1, wherein the housing body extends in a first direction, and the holder body extends in a second direction, the first direction being perpendicular to the second direction.

10. The inside rearview mirror assembly of claim 9, wherein the holder is a first holder, and the inside rearview mirror assembly further comprises a second holder spaced from the first holder along the first direction.

11. The inside rearview mirror assembly of claim 1, wherein the housing body is monolithically formed with the holder body.

12. A vehicle, comprising:
a vehicle body;
a windshield coupled to the vehicle body; and
an inside rearview mirror assembly configured to hold a tag, the inside rearview mirror assembly being coupled relative to the vehicle body, wherein the inside rearview mirror assembly comprises:
a mirror including a reflective surface facing the second end portion of the vehicle body;
a housing coupled to the mirror, the housing including a housing body and a holder protruding from the housing body in a direction toward the windshield, the holder including a holder body, the holder defining a groove disposed along the holder body, and the groove being configured to receive the tag; and
a stem coupled to the housing, the stem being fixed relative to the vehicle body, and the stem being spaced apart from the holder.

13. The vehicle of claim 12, wherein the housing body defines a center and the holder is offset from the center of the housing body.

14. The vehicle of claim 13, wherein the stem is coupled to the center of the housing body.

15. The vehicle of claim 12, wherein the housing body extends in a first direction, and the holder body extends in a second direction, the first direction being perpendicular to the second direction.

16. The vehicle of claim 12, wherein the holder has a cylindrical shape.

17. The vehicle of claim 12, further comprising a spacer disposed in the groove.

18. The vehicle of claim 16, wherein the spacer is made of an elastic material.

19. An inside rearview mirror housing capable of holding a tag, the inside rearview mirror housing comprising:
a housing body extending in a first direction; and
a holder protruding from the housing body, the holder including a holder body, the holder body extending in a second direction, the first direction being perpendicular to the second direction; and
wherein the holder defines a groove disposed along the holder body, and the groove is configured to receive the tag.

20. The inside rearview mirror housing of claim 19, wherein the housing body includes a first edge and a second edge, and the housing body has a housing length that extends from the first edge to the second edge, the housing body defines a midpoint of the housing length, and the holder is offset from the midpoint.
